(19) United States
(12) Patent Application Publication
(10) Pub. No.: US 2018/0349765 A1
(43) Pub. Date: Dec. 6, 2018

(54) LOG-LINEAR RECURRENT NEURAL NETWORK

(71) Applicant: Xerox Corporation, Norwalk, CT (US)

(72) Inventors: Marc Dymetman, Grenoble (FR); Chunyang Xiao, Grenoble (FR)

(21) Appl. No.: 15/607,867

(22) Filed: May 30, 2017

(51) Int. Cl. G06N 3/08; G06N 3/04

(52) U.S. Cl. CPC G06N 3/08; G06K 9/62; G06N 3/04

(57) ABSTRACT

A neural network apparatus includes a recurrent neural network having a long-linear output layer. The recurrent neural network is trained by training data and the recurrent neural network models outputs symbols as complex combinations of attributes without requiring that each combination among the complex combinations be directly observed in the training data. The recurrent neural network is configured to permit an inclusion of flexible prior knowledge in a form of specified modular features, wherein the recurrent neural network learns to dynamically control weights of a log-linear distribution to promote the specified modular features. The recurrent neural network can be implemented as a log-linear recurrent neural network.

### TECHNICAL FIELD

Embodiments are generally related to neural networks and specifically to a RNN (Recurrent Neural Network). Embodiments also relate to a Log-Linear RNN.

### BACKGROUND

Neural networks are machine-learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks are recurrent neural networks. A recurrent neural network is a neural network that receives an input sequence and generates an output sequence from the input sequence. In particular, a recurrent neural network can use some or all of the internal states of the network from a previous time step in computing an output at a current time step.

Recurrent Neural Networks have recently shown remarkable success in sequential data prediction and have been applied to such NLP (Natural Language Processing) tasks as Language Modeling, Machine Translation, Parsing, Natural Language Generation and Dialogue to name only a few. Especially popular RNN architectures in these applications have been models that are able to exploit long-distance correlations, such as those exploiting LSTM (Long Short Term Memory) and GRU (Gated Recurrent Unit) architectures, which have led to groundbreaking performances.

RNNs (or more generally Neural Networks), at the core, are machines that take as input a real vector and output a real vector through a combination of linear and non-linear operations.

When working with symbolic data, some conversion from these real vectors from and to discrete values, for instance words in a certain vocabulary, becomes necessary. However, most RNNs have taken an oversimplified view of this mapping. In particular, for converting output vectors into distributions over symbolic values, the mapping has mostly been done through a softmax operation, which assumes that the RNN is able to compute a real value for each individual member of the vocabulary, and then converts this value into a probability through a direct exponentiation followed by a normalization.

This rather crude “softmax approach,” which implies that the output vector has the same dimensionality as the vocabulary, has had some serious consequences.

To focus on only one symptomatic defect of this approach, consider the following. When using words as symbols, even large vocabularies cannot account for all the actual words found either in training or in test, and the models need to resort to a catch-all “unknown” symbol unk, which provides a poor support for prediction and requires to be supplemented by diverse pre- and post-processing steps. Even for words inside the vocabulary, unless they have been witnessed many times in the training data, prediction tends to be poor because each word is an “island,” completely distinct from and without relation to other words, which needs to be predicted individually.

One practical solution to the above problem involves changing the granularity by moving from word to character symbols. This has the benefit that the vocabulary becomes much smaller, and that all the characters can be observed many times in the training data. While character-based RNNs have thus some advantages over word-based ones, they also tend to produce non-words and to necessitate longer prediction chains than words, so the jury is still out with emerging hybrid architectures that attempt to capitalize on both levels.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved neural network apparatus.

It is another aspect of the disclosed embodiments to provide for an improved recurrent neural network.

It is yet another aspect of the disclosed embodiments to provide for a log-linear recurrent neural network.

The aforementioned aspects and other objectives and advantages can now be achieved as described herein. A neural network apparatus is disclosed, which includes a recurrent neural network having a log-linear output layer. The recurrent neural network is trained by training data, and the recurrent neural network models outputs symbols as complex combinations of attributes without requiring that each combination among the complex combinations be directly observed in the training data. The recurrent neural network is configured to permit an inclusion of flexible prior knowledge in a form of specified modular features, wherein the recurrent neural network learns to dynamically control weights of a log-linear distribution to promote the specified modular features. The recurrent neural network can be implemented as a log-linear recurrent neural network.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram of a generic RNN;

FIG. 2 illustrates a schematic diagram of a log-linear RNN, which can be implemented in accordance with an example embodiment;

FIG. 3 illustrates a schematic view of a computer system, in accordance with an embodiment; and

FIG. 4 illustrates a schematic view of a software system including a module, an operating system, and a user interface, in accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with “instruction” or “operation.”

The disclosed embodiments describe an approach different from that described in the background section of this disclosure. This different and unique approach removes the constraint that the dimensionality of the RNN output vector has to be equal to the size of the vocabulary and allows generalization across related words. However, its crucial benefit is that it introduces a principled and powerful way of incorporating prior knowledge inside the models.

The approach involves a very direct and natural extension of the softmax by considering it as a special case of a conditional exponential family, a class of models better known as log-linear models, and widely used in “pre-NN” NLP. The present inventors argue that this simple extension of the softmax allows the resulting “log-linear RNN” to compound the aptitude of log-linear models for exploiting prior knowledge and predefined features with the aptitude of RNNs for discovering complex new combinations of predictive traits.

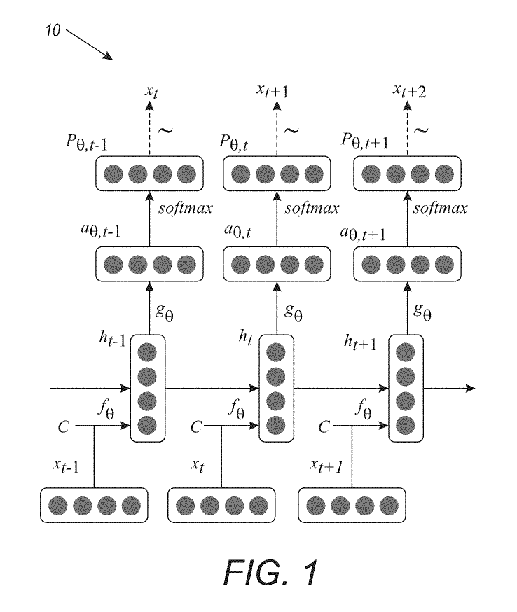

To provide an understanding of the disclosed embodiments, it is helpful to review the generic notion of an RNN and a brief review of log-linear models. FIG. 1 illustrates a schematic diagram of a generic RNN 10. FIG. 1 is presented to recap briefly the generic notion of an RNN, and differentiating an RNN from implementation styles such as, for example, LSTM, GRU, attention models, different number of layers, etc. An RNN is a generative process for predicting a sequence of symbols x₁, x₂, . . . , xₜ, . . . , where the symbols are taken in some vocabulary V, and where the prediction can be conditioned by a certain observed context C. This generative process can be written as:

p_{θ}(xₜ₊₁|C,x₁,x₂, . . . ,xₜ)

where θ is a real-valued parameter vector. Note that we will sometimes write this as p_{θ}(xₜ₊₁|C;x₁, x₂, . . . , xₜ) to stress the difference between the “context” C and the prefix x₁, x₂, . . . , xₜ. Note that some RNNs are “non-conditional” (i.e., do not exploit a context C). In any event, generically the aforementioned conditional probability can be computed according to the following as set forth equations (1), (2), (3), and (4) below:

hₜ=f_{θ}(C;xₜ,hₜ₋₁), (1)

a_{θ,t}=g_{θ}(hₜ), (2)

p_{θ,t}=softmax(a_{θ,t}), (3)

xₜ₊₁˜p_{θ,t}(·). (4)

Here, hₜ₋₁ is the hidden state at the previous step t−1, xₜ is the output symbol produced at that step and f_{θ} is a neural-network based function (e.g., a LSTM network) that computes the next hidden state hₜ based on C, xₜ, and hₜ₋₁. The function g_{θ} is then typically computed through an MLP, which returns a real-valued vector a_{θ,t} of dimension |V| (note: we do not distinguish between the parameters for f and for g, and can write θ for both). This vector can be then normalized into a probability distribution over V through the softmax transformation:

softmax(a_{θ,t})(x)=1/Zexp(a_{θ,t}(x)),

with the normalization factor:

$$Z = {\sum }_{{x}^{′} ∈ V} exp ( {a}_{θ , t} ( {x}^{′} ) ) ,$$

and finally, the next symbol xₜ₊₁ is sampled from this distribution. The training of such a model can be accomplished through back-propagation of the cross-entropy loss as follows:

−log p_{θ}(x̅ₜ₋₁|x₁,x₂, . . . ,xₜ;C),

where x̅ₜ₋₁ is the actual symbol observed in the training set.

Log-linear models play a considerable role in statistics and machine learning; special classes are often known through different names depending on the application domains and on various details: exponential families (typically for unconditional versions of the models), maximum entropy models, conditional random fields, and binomial and multinomial logistic regression. The models are especially popular in NLP, for example, in Language Modeling, in sequence labeling, and in machine translation to name a few.

Here we can follow the exposition of Jebara (2013), “Log-Linear Models, Logistic Regression and Conditional Random Fields,” which is incorporated herein by reference in its entirety. Such an exposition is useful for its broad applicability, and can define a conditional log-linear model—which we could also call a conditional exponential family—as a model of the form (in our own notation) as shown in equation (5) below:

$$p ( x \vert K , a ) = \frac{1}{Z ( K , a )} b ( K , x ) exp ( {a}^{⊤} φ ( K , x ) ) . \qquad ( 5 )$$

The notations can be described as follows. First x is a variable in a set V, which we will take here to be discrete (i.e., countable) and sometimes finite (note: the model is applicable over continuous (measurable) spaces, but to simplify the exposition we will concentrate on the discrete case, which permits the use of sums instead of integrals). We will use the terms domain or vocabulary for this set K is the conditioning variable (also called condition). The variable a is a parameter vector in [symbol] , which (for reasons that will appear later) we will refer to as the adaptor vector (note that in the NLP literature, this parameter vector is often denoted by λ). The variable ϕ is a feature function (K,x)→ [symbol] ; note that we sometimes write (x;K) or (K;x) instead of (K,x) to stress the fact that K is a condition. The variable b is a nonnegative function (K,x)→ [symbol] and this can be referred to as the background function of the model (which can also be referred to as the prior of the family). In addition, Z(K,a) is called the partition function and is a normalization factor as shown in equation (6) below:

$$p ( x ) = \frac{1}{Z} b ( x ) exp ( {a}^{⊤} φ ( x ) ) , \qquad ( 6 )$$

or more compactly as shown in equation (7) below:

p(z)∝b(x)exp(a^{T}ϕ(x)). (7)

If in equation (7) the background function is actually a normalized probability distribution over V (that is, Σₓb(x)=1) and if the parameter vector a is null, then the distribution p is identical to b. Suppose that we have an initial belief that the parameter vector a should be close to a₀, then by reparameterizing the equation in the form:

p(x)∝b′(x)exp(a′^{T}ϕ(x)), (8)

with b′(x)=b(x)exp(a₀^{T}ϕ(x)) and a′=a−a₀, then our initial belief is represented by taking a′=0. In other words, we can always assume that our initial belief is represented by the background probability b′ along with a null parameter vector a′=0. Deviations from this initial belief can then be represented by variations of the parameter vector away from 0 and a simple form regularization can be obtained by penalizing some p-norm |a′|ₚ of this parameter vector.

An important property of log-linear models is that they enjoy an extremely intuitive form of the gradient of their log-likelihood (aka cross-entropy loss). If x̅ is a training instance observed under condition K, and if the current model is p(x|a,K) according to equation (5), its negative likelihood at x̅ can be defined as −log L=−log p(x̅|a,K). Then a simple calculation shows that the gradient

$$\frac{\partial log L}{\partial a}$$

(also called the “Fisher score” at x̅) is given by equation (9) below:

$$\frac{\partial log L}{\partial a} = φ ( \overline{x} ; K ) - {\sum }_{x ∈ V} p ( x \vert a , K ) φ ( x ; K ) \qquad ( 9 )$$

In other words, the gradient is minus the difference between the model expectation of the feature vector and is actual value x̅ (in other words, the gradient is the difference between the feature vectors at the true labels minus the expected feature vectors under the current distribution).

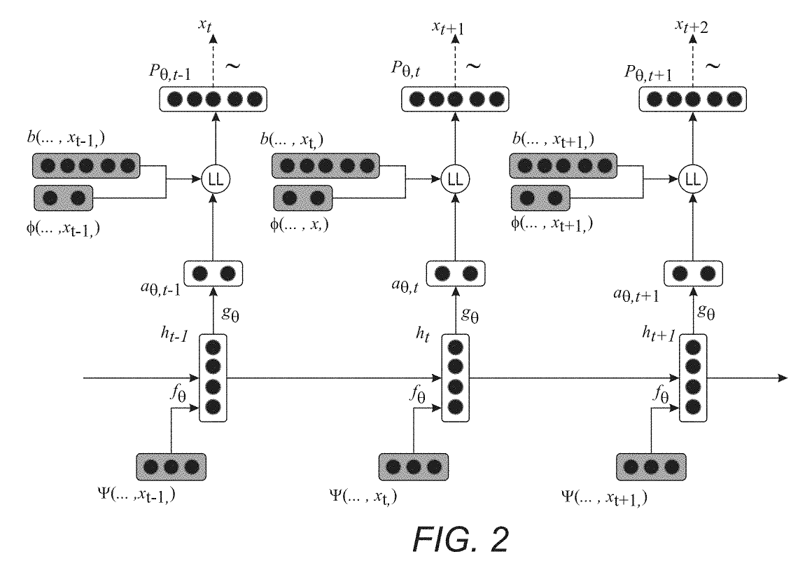

We can now define what we mean by a log-linear RNN (LL-RNN). The model, illustrated in FIG. 2, is similar to a standard RNN up to two important and significant differences. FIG. 2 thus illustrates a schematic diagram of a log-linear RNN, which can be implemented in accordance with an example embodiment. The first difference is that we allow a more general form of input to the network at each time step; namely, instead of allowing only the latest symbol xₜ to be used as input, along with the condition C, we now allow an arbitrary feature vector ψ(C, x₁, . . . , xₜ) to be used as input; this feature vector is of fixed dimensionability |ψ|, and we allow it to be computed in an arbitrary (but deterministic) way from the combination of the currently known prefix x₁, . . . , xₜ₋₁, xₜ and the context C. Although this may seem like a relatively minor change, it is actually a significant change because it usefully increases the expressive power of the network. We will sometime call the φ features the input features.

The second, major difference is the following. We do compute a_{θ,t} in the same way as previously from hₜ, however, after this point, rather than applying a softmax to obtain a distribution over V, we now apply a log-linear model. While for the standard RNN we had the following:

p_{θ,t}(xₜ₊₁)=soft max(a_{θ,t})(xₜ₊₁)

In the LL-RNN, we define:

p_{θ,t}(xₜ₊₁)∝b(C,x₁, . . . ,xₜ,xₜ₊₁)exp(a_{θ,t}^{T}ϕ(C,x₁, . . . ,xₜ,xₜ₊₁). (10)

In other words, we assume that we have a priori fixed a certain background function b(K, x), where the condition K is given by K=(C, x₁, . . . , xₜ), and also defined M features determining a feature vector ϕ(K,xₜ₊₁), of fixed dimensionability |ϕ|=M. We will sometimes call these features the output features. Note that both the background and the features have access to the context (C, x₁, . . . , xₜ).

In FIG. 2, we have indicated with LL (LogLinear) the operation (10) that combines a_{θ,t} with the feature vector ϕ(C, x₁, . . . , xₜ, xₜ₊₁) and the background b(C, x₁, . . . , xₜ, xₜ₊₁) to produce the probability distribution p_{θ,t}(xₜ₊₁) over V. We note that, here, a_{θ,t} is a vector of size |ϕ|, which may or may not be equal to size |V| of the vocabulary, by contrast to the case of the softmax of FIG. 1.

Overall, the LL-RNN is then computed through the following equations (11), (12), (13), and (14) as follows:

hᵢ=f_{θ}(ψ(C,x₁, . . . ,xₜ),hₜ₋₁), (11)

a_{θ,t}=g_{θ}(hₜ), (12)

p_{θ,t}(x)∝b(C,x₁, . . . ,xₜ,x)·exp(a_{θ,t}^{T}ϕ(C,x₁, . . . ,xₜ,x)), (13)

xₜ₊₁˜p_{θ,t}(·). (14)

For prediction, we now use the combined process p_{θ}, and we train this process, similarly to the RNN case, according to its cross-entropy loss relative to the actually observed symbol x̅ as shown in equation (15) below:

−log p_{θ}(x̅ₜ₊₁(C,x₁,x₂, . . . ,xₜ). (15)

At training time, in order to use this loss for back propagation in the RNN, we have to be able to compute its gradient relative to the previous layer, namely a_{θ,t}. From equation (9), we see that this gradient is given by equation (16):

$$( {\sum }_{x ∈ V} p ( x \vert {a}_{θ , t} , K ) φ ( K ; x ) ) - φ ( K ; {\overline{x}}_{t + 1} ) , \qquad ( 16 )$$

with K=C, x₁, x₂, . . . , xₜ.

This equation provides a particularly intuitive formula for the gradient, namely, as the difference between the expectation of ϕ(K;x) according to the log-linear model with parameters a_{θ,t} and the observed value ϕ(K;x̅ₜ₊₁). However, this expectation can be difficult to compute. For a finite (and not too large) vocabulary V, the simplest approach is to simply evaluate the right-hand side of equation (13) for each x∈V, to normalize by the sum to obtain p_{θ,t}(x), and to weight each ϕ(K;x) accordingly. For standard RNNs (which are special cases of LL-RNNs), this is actually what the simpler approaches to computing the softmax gradient do, but more sophisticated approaches have been proposed, such as employing a “hierarchical softmax.” In the general case (large or infinite V), the expectation term in equation (19) needs to be approximated, and different techniques may be employed, some specific to log-linear models, some more generic, such as contrastive divergence or Importance Sampling.

It is easy to see that LL-RNNs generalize RNNs. Consider a finite vocabulary V, and the |V|-dim “one not” representation of x∈V, relative to a certain fixed ordering of the elements of V as follows:

$$oneHot ( x ) = {[ 0 , 0 , … 1 , … 0 ]}_{ \begin{matrix}↑ \\ x\end{matrix}} .$$

We assume (as we implicitly did in the discussion of standard RNNs) that C is coded through some fixed-vector and we then define, as shown in equation (17)

ψ(C,x₁, . . . ,xₜ)=C⊕oneHot(xₜ), (17)

where the symbol ⊕ denotes vector concatenation; thus we “forget” about the initial portion x₁, . . . xₜ₋₁ of the prefix, and only take into account C and Xₜ, encoded in a similar way as in the case of RNNs.

We then define b(x) to be uniformly 1 for all x∈V (“uniform background”), and ϕ to be:

ϕ(C,x₁, . . . ,xₜ,xₜ₊₁)=oneHot(xₜ₊₁).

Neither b nor ϕ depend on C, x₁, . . . xₜ, and we have:

p_{θ,t}(xₜ₊₁)∝b(xₜ₊₁)exp(a_{θ,t}^{T}ϕ(xₜ₊₁))=expa_{θ,t}(xₜ₊₁),

In other words:

p_{θ,t}=softmax(a_{θ,t}).

Thus, we are back to the definition of RNNs in equations (1) to (4). As for the gradient computation of equation (19):

$$( {\sum }_{x ∈ V} p ( x \vert {a}_{θ , t} , K ) φ ( K ; x ) ) - φ ( K ; {\overline{x}}_{t + 1} ) , \qquad ( 18 )$$

It takes the simple form:

$$( {\sum }_{x ∈ V} {p}_{θ , t} ( x ) oneHot ( x ) ) - oneHot ( {\overline{x}}_{t + 1} ) , \qquad ( 19 )$$

in other words this gradient is a vector ∇ of dimension |V|, with coordinates i∈1, . . . , |V| corresponding to the different elements x₍ᵢ₎ of V, where:

$${▽}_{i} = \{ \begin{matrix}{p}_{θ , t} ( {x}_{( i )} ) - 1 & if {x}_{( i )} = {\overline{x}}_{t + 1} , \\ {p}_{θ , t} ( {x}_{( i )} ) & for the other {x}_{( i )} ’ s .\end{matrix} \qquad \begin{matrix}( 20 a ) \\ ( 20 b )\end{matrix}$$

This corresponds to the computation in the usual softmax case.

We now come back to our starting point in the introduction: the problem of unknown or rare words, and indicate a way to handle this problem with LL-RNNs, which may also help building intuition about these models.

Let us consider some moderately-sized corpus of English sentences, tokenized at the word level, and then consider the vocabulary V₁, of size 10K, composed of the 9999 most frequent words to occur in this corpus plus one special symbol UNK used for tokens not among those words (“unknown words”).

After replacing the unknown words in the corpus by UNK, we can train a language model for the corpus by training a standard RNN, for example, of the LSTM type. Note that if translated into an LL-RNN according to section 2.4, this model has 10K features (9999 features for identity with a specific frequent word, the last one for identify with the symbol UNK), along with a uniform background b.

This model, however, has some serious shortcomings. For example, suppose that none of the two tokens Grenoble and 37 belong to V₁ (i.e., to the 9999 most frequent words of the corpus), then the learnt model cannot distinguish the probability of the two test sentences: the cost was 37 euros/the cost was Grenoble euros.

Additionally, suppose that several sentences of the form the cost was NN euros appears in the corpus, with NN taking (for example) values 9, 13, 21, all belonging to V₁, and that on the other hand 15 also belongs to V₁, but appears in non-cost contexts; then the learnt model cannot give a reasonable probability to the cost was 15 euros, because it is unable to notice the similarity between 15 and the tokens 9, 13, 21.

We can now see how we can improve the situation by moving to the embodiment of an LL-RNN. We can start by extending V₁ to a much larger set of words V₂, in particular one that includes all the words in the union of the training and test corpora (note that later the restriction that V is finite can be lifted), and we keep b uniform over V₂. Concerning the input features, for now we keep them at their standard RNN values (namely as in equation (17)). Concerning the 4 features, we keep the 9999 word-identity features that we had, but note the UNK-identity one; however, we do add some new features (e.g., ϕ₁₀₀₀₀-ϕ₁₀₀₂₀).

For example, a binary feature ϕ₁₀₀₀₀(x)=ϕ_{number}(x) can be added that tells us whether the token x can be a number. In another example, a binary feature ϕ₁₀₀₀₁(x)=ϕ_{location}(x) tells us whether the token x can be a location, such as a city or a country. In yet another example, a few binary features ϕₙₒᵤₙ(x), ϕ_{adj}(x) . . . , covering the main POS's for English tokens may be added. Note that a single word may have simultaneously several such features firing, for instance, flies is both a noun and a verb (Note that rather than using the notation ϕ₁₀₀₀₀, . . . , we sometimes use the notation ϕ_{number}, . . . , for reasons of clarity). Some other features may be added, which cover other important classes of words.

Each of the ϕ₁, . . . , ϕ₁₀₀₂₀ features has a corresponding weight that we index in a similar way a₁, . . . , a₁₀₀₂₀.

Note again that we do allow the features to overlap freely, such that nothing prevents a word to be both a location and an adjective (e.g., Nice in We visited Nice/Nice flowers were seen everywhere), and to also appear in the 9999 most frequent words. For exposition reasons (i.e., in order to simplify the explanations below) we will suppose that a number N will always fire the feature ϕ_{number}, but no other feature, apart from the case where it belongs to V₁, in which case it will also fire the word-identify feature that corresponds to it, which we will denote by ϕ_{Ñ}, with Ñ≤9999

Why is this model superior to the standard RNN one? To answer this question, let us consider the encoding of N in ϕ feature space, when N is a number. There are two slightly different cases to consider:
1. N does not belong to V₁. Then we have ϕ₁₀₀₀₀=ϕ_{number}=1, and ϕᵢ=0 for other i's.
2. N belongs to V₁. Then we have ϕ₁₀₀₀₀=ϕ_{number}=1, ϕ_{N̅}=1, and ϕᵢ=0 for other i's.

Let us now consider the behavior of the LL-RNN during training, when at a certain point, for example, after having observed the prefix the cost was, it is now coming to the prediction of the next item xₜ₊₁=x, which we assume is actually a number x̅=N in the training sample. We start by assuming that N does not belong to V₁. Let us consider the current value a=a_{θ,t} of the weight vector calculated by the network at this point. According to equation (9), the gradient is:

$$\frac{\partial log L}{\partial a} = φ ( N ) - {\sum }_{x} p ( x \vert a ) φ ( x ) ,$$

where L is the cross-entropy loss and p is the probability distribution associated with the log-linear weights a.

In our case the first term is a vector that is null everywhere but on coordinate ϕ_{number}, on which it is equal to 1. As for the second term, it can be seen as the model average of the feature vector ϕ(x) when x is sampled according to p(x|a). One can see that this vector has all its coordinates in the interval [0, 1], and in fact strictly between 0 and 1 (this fact is because, for a vector a with finite coordinates, p(x|a) can never be 0, and also because we are making the mild assumption that for any feature ϕ₁ there exist x and x′ such that ϕᵢ(x)=−0, ϕᵢ(x′)=1; the strict inequalities follow immediately). As a consequence, the gradient

$$\frac{\partial log L}{\partial a}$$

is strictly positive on the coordinate ϕ_{number} and strictly negative on all the other coordinates. In other words, the back propagation signal sent to the neural network at this point is that it should modify its parameters ϕ_{number} in such a way as to increase the a_{number} weight, and decrease all the other weights in a.

A slightly different situation occurs if we assume now that N belongs to V₁. In that case ϕ(N) is null everywhere but on its two coordinates ϕ_{number} and ϕ_{N̅}, on which it is equal to 1. By the same reasoning as before we see that the gradient

$$\frac{\partial log L}{\partial a}$$

is then strictly positive on the two corresponding coordinates and strictly negative everywhere else. Thus, the signal sent to the network is to modify its parameters towards increasing the number a_{number} and a_{N̅} weights, and decrease them everywhere else.

Overall, on each occurrence of a number in the training set, the network is learning to increase the weights corresponding to the features (either both a_{number} and a_{N̅} or only a_{number}, depending on whether N is in V₁ or not) firing on this number, and to decrease the weights for all the other features. This contrasts with the behavior of the previously RNN model where in the case of N∈V₁ did the weight a_{N̅} change. This means that at the end of training, when predicting the word xₜ₊₁ that follows the prefix The cost was, the LL-RNN will have a tendency to produce a weight vector a_{θ,t} with especially high weight on a_{number}, some positive weights on those a_{N̅} for which N has appeared in similar contexts (note that if only numbers appeared in the context The cost was, then this would mean all “non-numeric” features, but such words as high, expensive, etc., may of course also appear, and their associated features would also receive positive increments).

Now, to come back to our initial example, let us compare the situation with the two next-word predictions The cost was 37 and The cost was Grenoble. The LL-RNN model predicts the next word xₜ₊₁ with probability:

$$\frac{\partial log L}{\partial a} = φ ( N ) - {\sum }_{x} p ( x \vert a ) φ ( x ) ,$$

While the prediction xₜ₊₁=37 tires the feature ϕ_{number}, the prediction xₜ₊₁=Grenoble does not fire any of the features that tend to be active in the context of the prefix The cost was, and therefore p_{θ,t}(37)>>p_{θ,t}(Grenoble). This is in stark contrast to the behavior of the original RNN, for which both 37 and Grenoble were undistinguishable unknown words.

We note that, while the model is able to capitalize on the generic notion of number through its feature ϕ_{number}, it is also able to learn to privilege certain specific numbers belonging to V₁ if they tend to appear more frequently in certain contexts. A log-linear model has the important advantage of being able to handle redundant features such as ϕ_{number} and ϕ_{3̅} which both fire on 3. Depending on prior expectations about typical texts in the domain being handled, it may then be useful to introduce features for distinguishing between different classes of numbers, for instance, “small numbers” or “year-like numbers,” allowing the LL-RNN to make useful generalizations based on these features. Such features need not be binary, for example, a small number feature could take values decreasing from 1 to 0, with the higher values reserved for the smaller numbers.

While our example focused on the case of numbers, it is clear that our observations equally apply to other features that we mentioned, such as ϕ_{location}(x), which can serve to generalize predictions in such contexts as We are traveling to.

In principle, generally speaking, any features that can support generalization, such as features representing semantic classes (e.g., nodes in the Wordnet hierarchy), morpho-syntactic classes (e.g., lemma, gender, number, etc.) or the like can be useful.

Note that the extension from softmax to log-linear outputs, while formally simple, opens a significant range of potential applications other than the handling of rare words. We now briefly sketch a few directions.

One application may involve a priori constrained sequences. For some applications, sequences to be generated may have to respect certain a priori constraints. One such case is the approach to semantic parsing, where starting from a natural language question an RNN decoder produces a sequential encoding of a logical form, which has to conform to a certain grammar. The model used is implicitly a simple case of LL-RNN, where (in our present terminology) the output feature vector 4 remains the usual oneHot, but the background b is not uniform anymore, but constrains the generated sequence to conform to the grammar.

Another application involves language model adaptation. We saw earlier that taking b to be uniform and ϕ to be an oneHot, an LL-RNN is just a standard RNN. The opposite extreme case is obtained by supposing that we already know the exact generative process for producing the xₜ₊₁ from the context K=C, x₁, x₂, . . . , xₜ. If we define b(K;·)=b(K;x) to be identical to this true underlying process, then in order to have the best performance in test, it is sufficient for the adaptor vector a_{θ,t} to be equal to the null vector, because then, according to equation (13), p_{θ,t}(x)∝b(K;x) is equal to the underlying process. The task for the RNN to learn a θ such that a_{θ,t} is null or close to null is an easy one (just take the higher level parameter matrices to be null or close to null), and in this case the adaptor has actually nothing to adapt to.

A more interesting, intermediary case is when b(K;x) is not too far from the true process. For example, b could be a word-based language model (e.g., n-gram type, LSTM type, etc.) trained on some large monolingual corpus, while the current focus is on modeling a specific domain for which much less data is available. Then training the RNN-based adaptor a_{θ} on the specific domain data would still be able to rely on b for test words not seen in the specific data, but learn to upweight the prediction of words often seen in these specific data (e.g., focusing on the simple case of an adaptor over an oneHot ϕ, as soon as a_{θ,t}(K;x) is positive on a certain word x, then the probability of this word is increased relative to what the background indicates).

Another potential application involves input features. In a standard RNN, a word xₜ is vector-encoded through a one-hot representation both when it is produced as the current output of the network, but also when it is used as the next input to the network. We previously saw the interest of defining the “output” features 4 to go beyond word-identity features (i.e., beyond the identification ϕ(x)=oneHot(x)) but we kept the “input” features as in standard RNNs, namely we kept ψ(j)=oneHot(x). However, we note an issue here. This usual encoding of the input x means that if x=37 has rarely (or not at all) been seen in the training data, then the network will have few clues to distinguish this word from another rarely observed word (for example, the adjective preposterous) when computing f_{θ} in equation (11). The network, in the context of the prefix the cost was, is able to give a reasonable probability to 37 thanks to ϕ. However, when assessing the probability of euros in the context of the prefix the cost was 37, this is not distinguished by the network from the prefix the cost was preposterous, which would not allow euros as the next word. A promising way to solve this problem here is to take ψ=ϕ, namely to encode the input x using the same features as the output x. This allows the network to “see” that 37 is a number and that preposterous is an adjective, and to compute its hidden state based on this information. We should note, however, that there is no requirement that ψ be equal to ϕ in general; the point is that we can include in ψ features, which can help the network predict the next word.

Another application involves infinite domains. As discussed previously, V₂ was large, but finite. This is quite artificial, especially if we want to account for words representing numbers, or words taken in some open-ended set, such as entity names. Let us go back to equation (5) defining log-linear models, and let us ignore the context K for simplicity wherein:

$$p ( x \vert \vert a ) = \frac{1}{Z ( a )} b ( x ) exp ( {a}^{⊤} φ ( x ) )$$

with

Z(a)=Σ_{x∈V}b(x)exp(a^{T}ϕ(x)).

when V is finite, then the normalization factor Z(a) is also finite, and therefore the probability p(x|a) is well defined; in particular, it is well-defined when b(x)=1 uniformly. However, when V is (countably) infinite, then this is unfortunately not true anymore. For instance, with b(x)=1 uniformly and with a=0, then Z(a) is infinite and the probability is undefined. By contrast, let us assume that the background function b is in L₁(V), i.e., Σ_{x∈V}b(x)<∞. Let us also suppose that the feature vector ϕ is uniformly bounded. Then, for any a, Z(a) is finite, and therefore p(x|a) is well defined.

Thus, the standard RNNs, which have (implicitly) a uniform background b, have no way to handle infinite vocabularies, while LL-RNNs, by using a finite-mass b, can. One simple way to ensure that property on tokens representing numbers, for example, is to associate them with a geometric background distribution, decaying fast with their length, and a similar treatment can be accomplished for named entities.

Another application involves condition-based priming. Many applications of RNNs, such as machine translation or natural language generation depend on a condition C (e.g., source sentence, semantic representation, etc.). When translated into LL-RNNs, this condition is taken into account through the input vector:

ψ(C,x₁. . . ,xₜ)=C⊕oneHot(xₜ)

(see equation (17)), but does not appear in

b(C,x₁, . . . ,xₜ;xₜ₊₁)=b(xₜ₊₁)=1

or

ϕ(C,x₁, . . . ,xₜ;xₜ₊₁)=oneHot(xₜ₊₁).

However, there is opportunity for exploiting the condition inside b or ϕ. To sketch a simple example, in NLG, one may be able to predefine some weak unigram language model for the realization that depends on the semantic input C, for example, by constraining named entities that appear in the realization to have some evidence on the input. Such a language model can be usefully represented through the background process b(C, x₁, . . . , xₜ;xₜ₊₁)=b(C;xₜ₊₁), providing a form of “priming” for the combined LL-RNN, helping it to avoid irrelevant tokens.

As can be appreciated by one skilled in the art, embodiments can be implemented in the context of a method, data processing system, or computer program product. Accordingly, embodiments may take the form of an entire hardware embodiment, an entire software embodiment, or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer, or entirely on the remote computer. In the latter scenario, the remote computer may be connected to a user's computer through a local area network (LAN) or a wide area network (WAN), wireless data network e.g., Wi-Fi, Wimax, 802.xx, and cellular network, or the connection may be made to an external computer via most third party supported networks (for example, through the Internet utilizing an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks. To be clear, the disclosed embodiments can be implemented in the context of, for example, a special-purpose computer or a general-purpose computer, or other programmable data processing apparatus or system. For example, in some embodiments, a data processing apparatus or system can be implemented as a combination of a special-purpose computer and a general-purpose computer.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

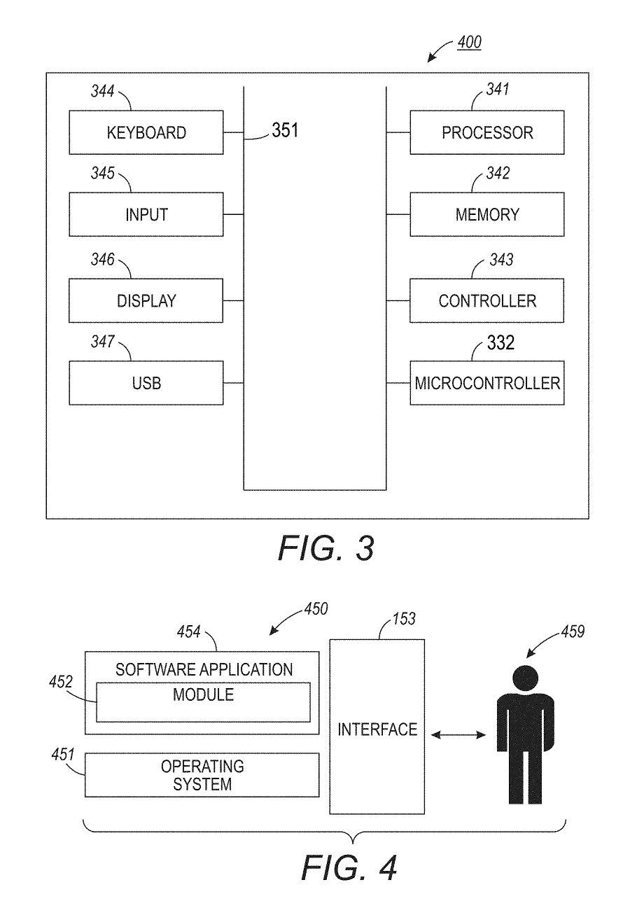

FIGS. 3-4 are shown only as exemplary diagrams of data-processing environments in which example embodiments may be implemented. It should be appreciated that FIGS. 3-4 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 3, some embodiments may be implemented in the context of a data-processing system 400 that can include, for example, one or more processors such as a processor 341 (e.g., a CPU (Central Processing Unit) and/or other microprocessors), a memory 342, an input/output controller 343, a microcontroller 332, a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc.), and/or other peripheral connections and components.

As illustrated, the various components of data-processing system 400 can communicate electronically through a system bus 351 or similar architecture. The system bus 351 may be, for example, a subsystem that transfers data between, for example, computer components within data-processing system 400 or to and from other data-processing devices, components, computers, etc. The data-processing system 400 may be implemented in some embodiments as, for example, a server in a client-server based network (e.g., the Internet) or in the context of a client and a server (i.e., where aspects are practiced on the client and the server).

In some example embodiments, data-processing system 400 may be, for example, a standalone desktop computer, a laptop computer, a Smartphone, a pad computing device and so on, wherein each such device is operably connected to and/or in communication with a client-server based network or other types of networks (e.g., cellular networks, Wi-Fi, etc.).

FIG. 4 illustrates a computer software system 450 for directing the operation of the data-processing system 400 depicted in FIG. 3. Software application 454 stored, for example, in memory 342, generally includes a kernel or operating system 451 and a shell or interface 453. One or more application programs, such as software application 454, may be “loaded” (i.e., transferred from, for example, mass storage or another memory location into the memory 342) for execution by the data-processing system 400. The data-processing system 400 can receive user commands and data through the interface 453; these inputs may then be acted upon by the data-processing system 400 in accordance with instructions from operating system 451 and/or software application 454. The interface 453 in some embodiments can serve to display results, whereupon a user 459 may supply additional inputs or terminate a session. The software application 454 can include module(s) 452, which can, for example, implement instructions or operations such as those discussed herein with respect to FIG. 3 herein. Module 452 may also be composed of a group of modules. Module 452 can be configured, for example, to implement instructions such as those described herein with respect to FIGS. 1-2. For example, in some embodiments, module 452 may function as a recurrent neural network or as log-linear RNN with instructions and parameters as described herein. In such a situation, the data processing apparatus 400 may function as a neural network apparatus as described and claimed herein.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

FIGS. 3-4 are thus intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

The claims, description, and drawings of this application may describe one or more of the instant technologies in operational/functional language, for example, as a set of operations to be performed by a computer. Such operational/functional description in most instances can be specifically-configured hardware (e.g., because a general purpose computer in effect becomes a special-purpose computer once it is programmed to perform particular functions pursuant to instructions from program software). Note that the data-processing system 400 discussed herein may be implemented as special-purpose computer in some example embodiments. In some example embodiments, the data-processing system 400 can be programmed to perform the aforementioned particular instructions thereby becoming in effect a special-purpose computer.

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein can be a distillation of machine specifications or other physical mechanisms specified by the operations/functions such that the otherwise inscrutable machine specifications may be comprehensible to the human mind. The distillation also allows one skilled in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions are representative of static or sequenced specifications of various hardware elements. This is true because tools available to implement technical disclosures set forth in operational/functional formats-tools in the form of a high-level programming language (e.g., C, java, visual basic), etc., or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. In order to facilitate human comprehension, in many instances, high-level programming languages resemble or even share symbols with natural languages.

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In an example embodiment, if a high-level programming language is the tool used to implement a technical disclosure in the form of functions/operations, it can be understood that, far from being abstract, imprecise, “fuzzy,” or “mental” in any significant semantic sense, such a tool is instead a near incomprehensibly precise sequential specification of specific computational—machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory devices, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors).

The logic circuits forming the microprocessor are arranged to provide a micro architecture that will carry out the instructions defined by that microprocessors defined Instruction Set Architecture. The Instruction Set Architecture is the part of the microprocessor architecture related to programming, including the native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second).

Thus, programs written in machine language-which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification, which selects out hardware logic gates, specifies voltage levels, voltage transition timings, etc., such that the humanly useful work is accomplished by the hardware.

Thus, a functional/operational technical description, when viewed by one skilled in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. Accordingly, any such operational/functional technical descriptions may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object, which has a stable, measurable, and changeable state may be used to construct a machine based on the above technical description. Charles Babbage, for example, constructed the first computer out of wood and powered by cranking a handle.

Thus, far from being understood as an abstract idea, it can be recognized that a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc., with natural language simply cannot be taken as an indication that such functional/operational technical descriptions are abstract ideas, or mere expressions of abstract ideas. In fact, as outlined herein, in the technological arts this is simply not true. When viewed through the tools available to those skilled in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person skilled in the art in understanding the described subject matter by providing a description that is more or less independent of any specific vendor's piece(s) of hardware.

The use of functional/operational technical descriptions assists the person skilled in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person skilled in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those skilled in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one skilled in the art can readily understand and apply in a manner independent of a specific vendor's hardware implementation.

At least a portion of the devices or processes described herein can be integrated into an information processing system. An information processing system generally includes one or more of a system unit housing, a video display device, memory, such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), or control systems including feedback loops and control motors (e.g., feedback for detecting position or velocity, control motors for moving or adjusting components or quantities). An information processing system can be implemented utilizing suitable commercially available components, such as those typically found in data computing/communication or network computing/communication systems.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes or systems or other technologies described herein can be effected (e.g., hardware, software, firmware, etc., in one or more machines or articles of manufacture), and that the preferred vehicle will vary with the context in which the processes, systems, other technologies, etc., are deployed. For example, if an implementer determines that speed and accuracy are paramount, the implementer may opt for a mainly hardware or firmware vehicle; alternatively, if flexibility is paramount, the implementer may opt for a mainly software implementation that is implemented in one or more machines or articles of manufacture; or, yet again alternatively, the implementer may opt for some combination of hardware, software, firmware, etc., in one or more machines or articles of manufacture. Hence, there are several possible vehicles by which the processes, devices, other technologies, etc., described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. In an embodiment, optical aspects of implementations will typically employ optically-oriented hardware, software, firmware, etc., in one or more machines or articles of manufacture.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably coupleable” to each other to achieve the desired functionality. Specific examples of operably coupleable include, but are not limited to, physically mateable, physically interacting components, wirelessly interactable, wirelessly interacting components, logically interacting, logically interactable components, etc.

In an example embodiment, one or more components may be referred to herein as “configured to,” “configurable to,” “operable/operative to,” “adapted/adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and/or firmware would be well within the skill of one skilled in the art in light of this disclosure. In addition, the mechanisms of the subject matter described herein are capable of being distributed as a program product in a variety of forms, and that an illustrative embodiment of the subject matter described herein applies regardless of the particular type of signal-bearing medium used to actually carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While particular aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), it should be understood that the various operations may be performed in orders other than those that are illustrated, or may be performed concurrently. Examples of such alternate orderings include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Based on the foregoing, it can be appreciated that a number of example embodiments are disclosed herein. For example, in one embodiment, a neural network apparatus can be implemented, which includes a recurrent neural network having a log-linear output layer, the recurrent neural network trained by training data, and wherein the recurrent neural network models outputs symbols as complex combinations of attributes without requiring that each combination among the complex combinations be directly observed in the training data. The recurrent neural network can be configured to permit an inclusion of flexible prior knowledge in a form of specified modular features, wherein the recurrent neural network learns to dynamically control weights of a log-linear distribution to promote the specified modular features.

In another example embodiment, the recurrent neural network can be a log-linear recurrent neural network. In yet another example embodiment, the recurrent neural network can be composed of a machine that receives a real vector as an input and outputs a real vector through a combination of linear operations and non-linear operations. In still another example embodiment, the recurrent neural network can be configured from a log-linear model that includes the log-linear output layer, wherein the log-linear model includes cross-entropy loss.

In some example embodiments, the recurrent neural network can be utilized to train a language model. In yet other example embodiments, the recurrent neural network ca be utilized for language model adaptation. In another example embodiment, the recurrent neural network can be utilized for condition-based priming. In still another example embodiment, the recurrent neural network can be utilized for condition-based priming.

In another example embodiment, a neural network method can be implemented. Such a method can includes steps, instructions, or operations such as providing a recurrent neural network with a log-linear output layer, training the recurrent neural network by training data such that the recurrent neural network models outputs symbols as complex combinations of attributes without requiring that each combination among the complex combinations be directly observed in the training data; and configuring the recurrent neural network to permit an inclusion of flexible prior knowledge in a form of specified modular features, wherein the recurrent neural network learns to dynamically control weights of a log-linear distribution to promote the specified modular features.

In yet another example embodiment, a neural network system can be implemented, which includes, for example, at least one processor (i.e., one or more processors), and a non-transitory computer-usable medium embodying computer program code. The computer-usable medium is capable of communicating with the at least one processor. The computer program code can include instructions executable by the at least one processor and configured for: providing a recurrent neural network with a log-linear output layer; training the recurrent neural network by training data such that the recurrent neural network models outputs symbols as complex combinations of attributes without requiring that each combination among the complex combinations be directly observed in the training data; and configuring the recurrent neural network to permit an inclusion of flexible prior knowledge in a form of specified modular features, wherein the recurrent neural network learns to dynamically control weights of a log-linear distribution to promote the specified modular features.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A neural network apparatus, comprising:
a recurrent neural network having a log-linear output layer, said recurrent neural network trained by training data and wherein said recurrent neural network models outputs symbols as complex combinations of attributes without requiring that each combination among said complex combinations be directly observed in said training data, and wherein said recurrent neural network is configured to permit an inclusion of flexible prior knowledge in a form of specified modular features, wherein said recurrent neural network learns to dynamically control weights of a log-linear distribution to promote said specified modular features.

2. The neural network apparatus of claim 1 wherein said recurrent neural network comprises a log-linear recurrent neural network.

3. The neural network apparatus of claim 1 wherein said recurrent neural network comprises a machine that receives a real vector as an input and outputs a real vector through a combination of linear operations and non-linear operations.

4. The neural network apparatus of claim 1 wherein said recurrent neural network comprises a log-linear model that includes said log-linear output layer, wherein said log-linear model includes cross-entropy loss.

5. The neural network apparatus of claim 1 wherein said recurrent neural network is utilized to train a language model.

6. The neural network apparatus of claim 1 wherein said recurrent neural network is utilized for language model adaptation.

7. The neural network apparatus of claim 1 wherein said recurrent neural network is utilized for condition-based priming.

8. The neural network of claim 1 wherein said recurrent neural network is utilized for condition-based priming.

9. A neural network method, said method comprising:
providing a recurrent neural network with a log-linear output layer;
training said recurrent neural network by training data such that said recurrent neural network models outputs symbols as complex combinations of attributes without requiring that each combination among said complex combinations be directly observed in said training data; and
configuring said recurrent neural network to permit an inclusion of flexible prior knowledge in a form of specified modular features, wherein said recurrent neural network learns to dynamically control weights of a log-linear distribution to promote said specified modular features.

10. The neural network method of claim 9 wherein said recurrent neural network comprises a log-linear recurrent neural network.

11. The neural network method of claim 9 wherein said recurrent neural network comprises a machine that receives a real vector as an input and outputs a real vector through a combination of linear operations and non-linear operations.

12. The neural network method of claim 9 wherein said recurrent neural network comprises a log-linear model that includes said log-linear output layer, wherein said log-linear model includes cross-entropy loss.

13. The neural network method of claim 9 wherein said recurrent neural network is utilized to train a language model.

14. The neural network method of claim 9 wherein said recurrent neural network is utilized for language model adaptation.

15. The neural network method of claim 9 wherein said recurrent neural network is utilized for condition-based priming.

16. A neural network system, said system comprising:
at least one processor; and
a non-transitory computer-usable medium embodying computer program code, said computer-usable medium capable of communicating with said at least one processor, said computer program code comprising instructions executable by said at least one processor and configured for:
providing a recurrent neural network with a log-linear output layer;
training said recurrent neural network by training data such that said recurrent neural network models outputs symbols as complex combinations of attributes without requiring that each combination among said complex combinations be directly observed in said training data; and
configuring said recurrent neural network to permit an inclusion of flexible prior knowledge in a form of specified modular features, wherein said recurrent neural network learns to dynamically control weights of a log-linear distribution to promote said specified modular features.

17. The neural network system of claim 16 wherein said recurrent neural network comprises a log-linear recurrent neural network.

18. The neural network system of claim 16 wherein said recurrent neural network comprises a machine that receives a real vector as an input and outputs a real vector through a combination of linear operations and non-linear operations.

19. The neural network system of claim 16 wherein said recurrent neural network comprises a log-linear model that includes said log-linear output layer, wherein said log-linear model includes cross-entropy loss.

20. The neural network system of claim 16 wherein said recurrent neural network is utilized for at least one of the following: training a language model, language model adaptation, or condition-based priming.
